(19) United States
(12) Patent Application Publication
(10) Pub. No.: US 2010/0293061 A1
(43) Pub. Date: Nov. 18, 2010

(54) COMPUTER DEVICE, METHOD, AND GRAPHICAL USER INTERFACE FOR AUTOMATING THE DIGITAL TRANSFORMATION, ENHANCEMENT, AND DATABASE CATALOGING OF PRESENTATION VIDEOS

(75) Inventor: Matthew Benjamin Singer, New York, NY (US)

Correspondence Address: Ward & Olivo LLP, 382 Springfiled Avenue, Summit, NJ, 07901, US

(73) Assignee: The Talk Market, Inc., New York, NY (US)

(21) Appl. No.: 12/693,254

(22) Filed: Jan. 25, 2010

Related U.S. Application Data
(60) Provisional application No. 61/205,841, filed on Jan. 23, 2009.
(60) Provisional application No. 61/239,041, filed on Sep. 1, 2009.

(51) Int. Cl. G06Q 30/00; G06F 3/048; G06F 15/16

(52) U.S. Cl. 705/14.72; 715/719; 709/217

(57) ABSTRACT

A computer-implemented method is described for receiving at a computer identification of a product or service that is to be the subject of a video presentation, generating at the computer step-by-step guidance to a user specific to the subject of the video presentation on what to say in the video presentation, when to say it and how to record the subject of the video presentation, providing the step-by-step guidance from the computer to the user, receiving the video presentation at the computer and editing the video presentation at the computer. In some embodiments, the presentation is automatically processed to enhance it by combining it with additional audiovisual material, to compress it, to format it for Internet or broadcast delivery, and/or to route it for Internet or broadcast delivery. Computer apparatus for performing these steps is also described.

This application claims the benefit of the Jan. 23, 2009 filing date of provisional application Ser. No. 61/205,841 and the Sep. 1, 2009 filing date of provisional application Ser. No. 61/239,041, both of which applications are incorporated herein by reference.

### BACKGROUND

This relates to the digital transformation, enhancement, and cataloging of sales or presentation audiovisuals.

Billions of dollars of products and services are currently sold each year on television sales channels such as QVC, HSN and ShopNBC. These channels demonstrate the power that an expertly crafted presentation video can have in selling products and services. However, there has not been wide adoption of massive quantities of this type of presentation video content on the major ecommerce channels such as Amazon, eBay, and Walmart.com. There are several reasons for this lack of adoption:

a) Time. High quality video production workflow can take 30× resultant video time. For example, a 2 minute video typically takes 75 minutes to complete and upload to a product listing page on an ecommerce website (see FIG. 11). Thus, for a website with tens of thousands of product listings (or millions in the case of Amazon), it would be nearly impossible with video creation methods currently available to create human-talent based video sales presentations on a massive scale.

b) Cost. Most Internet or electronic commerce companies do not have the internal staff to create videos, and at current discount rates, outsourced video creation firms typically charge $1,000 for a 2 minute sales video. Thus, creating tens of thousands of these videos (or millions in the case of Amazon) would be excessively expensive.

c) Expertise. Simply put, not just any video properly enhances sales or presentation in the proven fashion of television shopping channels. Human talent-based sales presentations, as created by the proven TV shopping channels, involve an actual person speaking into the camera or demonstrating a product or service with live action. Such presentations are much more effective for sales than simple animated montages of still images. Moreover, it takes a specialized expertise not only for the selling party within the sales video to know what to say, when to say it, and how to say it depending on the product or service that he or she is selling or the idea he or she is presenting, but also to optimally digitize the audio and visual components of the presentation into audiovisual files and compress and enhance those audiovisual files in the optimal way to create an appropriately compact and professional grade audiovisual file. Most companies do not have the internal expertise to effectively execute these operations and create their own source content for a sales or presentation video.

Thus, the above combination of excessive time, cost, and rare expertise result in limited use of presentation videos on a massive scale in electronic commerce beyond traditional TV shopping channels which have giant video production staffs and studios with huge overhead costs. Accordingly, there is a need for methods and apparatus that can transform the process of creating presentation videos through automation of the creation, enhancement and cataloging of said audiovisuals, using machines that are easy to use, configure, and/or adapt. Such machines increase the effectiveness, efficiency and user satisfaction with massively scaled video production, thereby opening up the proven, powerful results of scaleable video presentation to a much wider group of business and personal applications.

### SUMMARY OF THE PRESENT INVENTION

The above deficiencies and other problems associated with massive levels of presentation video production are reduced or eliminated by the disclosed multifunction device and methods. In some embodiments, the device is a computer with a tethered camera with a graphical user interface (GUI), one or more processors, memory, and one or more modules, programs or sets of instructions stored in the memory for performing multiple functions nearby the user. In some embodiments, the user interacts with the GUI primarily through a local computer and camera connected to the device via a network. Computer instructions for performing these functions may be included in a computer readable storage medium or other computer program product configured for execution by one or more processors.

In one embodiment, the computer instructions include: instructions for receiving at the computer identification of a product or service that is to be the subject of the video presentation, instructions for generating at the computer step-by-step guidance to a user specific to the subject of the video presentation on what to say in the video presentation, when to say it and how to film the subject of the video presentation, instructions for providing the step-by-step guidance from the computer to the user, instructions for providing from the computer to the user review criteria at the completion of at least one step in the creation of the video presentation, and instructions for editing the video presentation at the computer.

In another embodiment, the invention is a computer-implemented method for receiving at the computer identification of a product or service that is to be the subject of the video presentation, generating at the computer step-by-step guidance to a user specific to the subject of the video presentation on what to say in the video presentation, when to say it and how to film the subject of the video presentation, providing the step-by-step guidance from the computer to the user, providing from the computer to the user review criteria at the completion of at least one step in the creation of the video presentation, and editing the video presentation at the computer.

In another embodiment, a computer-implemented method for use in conjunction with a computing device connected to a camera comprises: receiving information about a product, profile, service, or presentation at the device; generating directives optimized for maximum sales or positive positioning of subject in response to said information; automatically editing a video presentation created in response to the directives; and further transforming the digital audiovisual files resulting from such editing by adding additional enhancements to the footage including layers of audio and video such as soundtracks and motion graphics, with the device contracting and enhancing the audiovisual files automatically. In some embodiments, the method further comprises configuring a destination file directory (local and/or remote) for the finished presentation videos; and editing and cataloging the audiovisual elements automatically without further user input. In some embodiments, the automatic editing and cataloging further comprise transforming the digital audiovisual files by automatically separating audio and video portions of footage; recombining audio and video portions of footage according to predetermined rules in order to compress and enhance the audiovisual files; and transferring resultant enhanced video and related metadata to a database server for later network based delivery in conjunction with an ecommerce product detail web page or user profile, all without the need for further user input. As a result, the user is relieved of a) the need to know how to operate traditional manual video editing software; b) the need to take the time to operate traditional manual video editing software; and c) the need to know the optimal techniques for operating said traditional manual video editing software, thereby producing time, expertise, and resource savings in the creation of the presentation audiovisuals.

In some embodiments, information is received at the computing device at substantially the same time about a plurality of products, profiles, services, or presentations; and the directives for the video presentations that are generated in response to this information are organized so as to direct the formation of at least one same or similar portion of each video presentation in a series, one portion after the other. The various portions of each video presentation are then automatically edited so as to assemble a correctly ordered video presentation for each of the plurality of products, profiles, services or presentations. By organizing the directives for the video presentations so as to group together the same or similar portions of a plurality of presentations, it may be possible to achieve significant efficiencies and cost savings in the preparation of a plurality of video presentations.

In some embodiments, additional efficiencies may also be achieved by extracting from the video file any still images that may be needed for the online video presentation. Such image or images may be extracted automatically from specified portions of the finished video presentation or they may be extracted manually using a process in which the user employs an interface to view and select the optimal video frame(s).

The above embodiments can also be used in other types of sales or presentation video applications by individuals, including on Internet job websites, Internet dating websites, social networking websites, news websites, or educational websites, product profiles, product sales pitches, company profiles, or company sales pitches.

### BRIEF DESCRIPTION OF THE DRAWINGS

These and other objects, features and advantages will be more readily apparent from the following Detailed Description in which:

FIG. 1 is a schematic diagram of the computing device used in the practice of the invention;

FIG. 2 is a schematic diagram illustrating examples of how the resultant digitally transformed audiovisuals would be utilized in the context of electronic commerce, broadcast commerce, user profiles, or social media;

FIGS. 3A, 3B and 3C are flowcharts of illustrative embodiments of the invention;

FIG. 4 to FIG. 10 are images of the GUI at several points in the processes of FIGS. 3A, 3B and 3C; and

FIG. 11 is an illustration of the transformative steps taken by the device that result in time saved and resources saved with the digital enhancement automation of the present invention.

### DETAILED DESCRIPTION

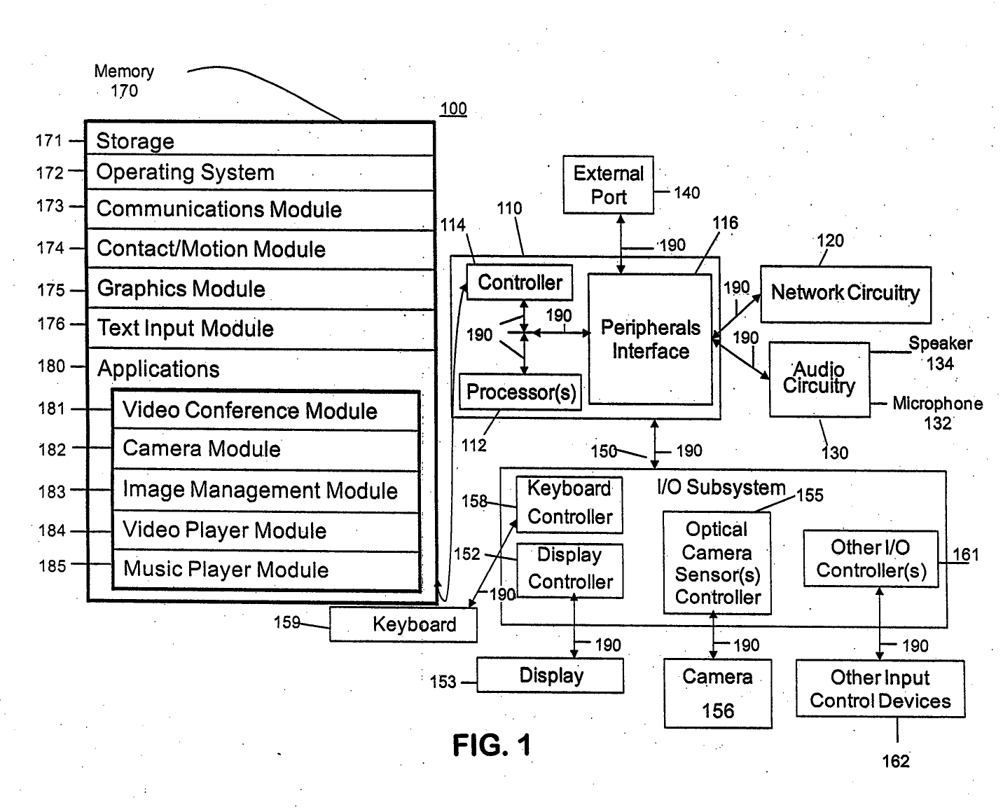

FIG. 1 is a schematic diagram of a computing device 100 used in the practice of the invention. Reference is made in detail to embodiments, examples of which are illustrated in the accompanying drawings. In the following schematic, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

Device 100 comprises a processing unit 110, network interface circuitry 120, audio circuitry 130, external port 140, an I/O subsystem 150 and a memory 170. Processing unit comprises one or more processors 112, a memory controller 114, and a peripherals interface 116, connected by a bus 190. I/O subsystem includes a display controller 152 and a display 153, one or more camera controllers 155 and associated camera(s) 156, a keyboard controller 158 and keyboard 159, and one or more other I/O controllers 161 and associated I/O 162. Memory 170 provides general purpose storage 171 for device 100 as well as storage for software for operating the device including an operating system 172, a communication module 173, a contact/motion module 174, a graphics module 175, a text input module 176, and various application programs 180. The applications programs include a video conference module 182, a camera module 183, an image management module 184, a video player module 185 and a music player module 186.

The network interface circuitry 120 communicates with communications networks via electromagnetic signals. Network circuitry 120 may include well-known communication circuitry including but not limited to an antenna system, a network transceiver, one or more amplifiers, a tuner, one or more oscillators, a digital signal processor, a CODEC chipset, a subscriber identity module (SIM) card, memory, and so forth. Network circuitry 120 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 130, including a microphone 132 and a speaker 134, provides an audio interface between a user and the device 100. The audio circuitry 130 receives digital audio data from the peripherals interface 116, converts the digital audio data to an analog electrical signal, and transmits the electrical signal to the speaker 134. The speaker 134 converts the analog electrical signal to human-audible sound waves. The audio circuitry 130 also receives analog electrical signals converted by the microphone 132 from sound waves and converts the analog electrical signal to digital audio data that is transmitted to the peripherals interface 116 for processing. Digital audio data may be retrieved from and/or transmitted to memory 170 and/or the network interface circuitry 120 by the peripherals interface 116. In some embodiments, the audio circuitry 130 also includes a USB audio jack. The USB audio jack provides an interface between the audio circuitry 130 and removable audio input/output peripherals, such as output-only headphones or a microphone.

The I/O subsystem 150 couples input/output peripherals on the device 100, such as a display 153, a camera 156, a keyboard 159 and other input/control devices 162, to the peripherals interface 116. The I/O subsystem 150 may include a display controller 152, a camera controller 155, a keyboard controller 158, and one or more other input/output controllers 161 for other input or output devices. The one or more other I/O controllers 161 receive/send electrical signals from/to other input/output devices 162. The other input/control devices 162 may include physical buttons (e.g., push buttons, rocker buttons, etc.), dials, slider switches, joysticks, click wheels, and so forth. In some alternate embodiments, I/O controller(s) 161 may be coupled to any (or none) of the following: an infrared port, USB port, and a pointer device such as a mouse. The one or more buttons may include an up/down button for volume control of the speaker 134 and/or the microphone 132.

The device 100 may also include one or more video cameras 156. The video camera may include charge-coupled device (CCD) or complementary metal-oxide semiconductor (CMOS) phototransistors. The video camera receives light from the environment, projected through one or more lens, and converts the light to data representing an image. In conjunction with an imaging module, the video camera may be embedded within the computing device, and in some embodiments, the video camera can be encompassed in a separate camera housing for both video conferencing and still and/or video image acquisition.

Memory 170 may include high-speed random access memory and may also include non-volatile memory, such as one or more magnetic disk storage devices, flash memory devices, or other non-volatile solid-state memory devices. Access to memory 170 by other components of the device 100, such as the processor(s) 112 and the peripherals interface 116, may be controlled by the memory controller 114.

The operating system 172 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 173 facilitates communication with other devices over one or more external ports 140 and also includes various software components for handling data received by or transmitted from the network interface circuitry 120.

The graphics module 175 includes various known software components for rendering and displaying the GUI, including components for changing the intensity of graphics that are displayed. As used herein, the term “graphics” includes any object that can be displayed to a user, including without limitation text, icons (such as user-interface objects including soft keys), digital images, videos, animations and the like.

In conjunction with keyboard 159, display controller 152, camera(s) 156, camera controller 155 and graphics module 175, the camera module 183 may be used to capture still images or video (including a video stream) and store them in memory 170, modify characteristics of a still image or video, or delete a still image or video from memory 170. Embodiments of user interfaces and associated processes using camera(s) 156 are described further below.

In conjunction with keyboard 159, display controller 152, display 153, graphics module 175. audio circuitry 130, and speaker 134, the video player module 185 may be used to display. present or otherwise play back videos (on an external, connected display via external port 140 or an internal display). Embodiments of user interfaces and associated processes using video player module 185 are described further below.

It should be appreciated that the device 100 is only one example of a multifunction device, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

In some embodiments, the peripherals interface 116, the CPU 112, and the memory controller 114 may be implemented on a single integrated circuit chip. In some other embodiments, they may be implemented on separate chips.

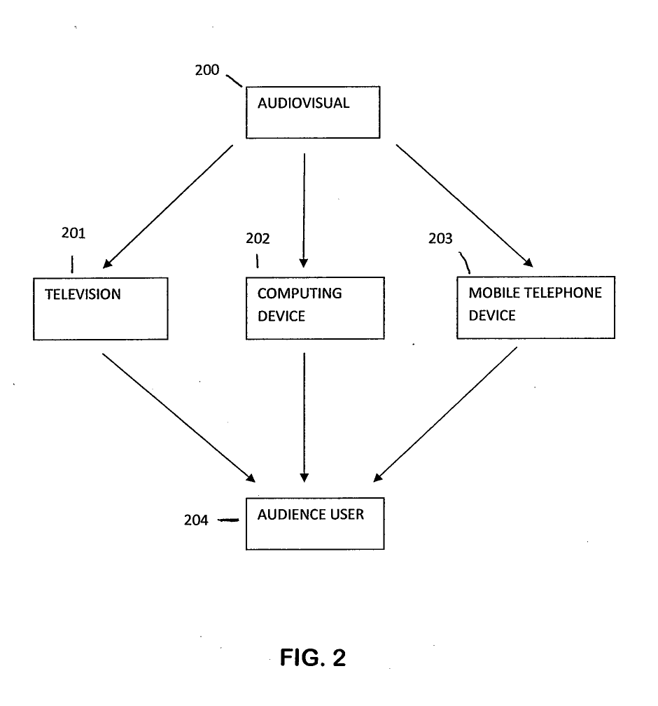

FIG. 2 is a schematic illustrating how the resultant digitally transformed audiovisuals are utilized in personal or commercial contexts. Audiovisual 200 can be displayed through television 201, computing device 202, telephone device 203, or any other electronic device that can display audiovisuals, and advertise or showcase the person, product, or service featured within the audiovisual. Audience user 204 views audiovisual 200 through any of these display devices and can respond to the offer or presentation in a more informed fashion because of the addition of the enhanced audiovisual. User 204 responds through any means of digital or analog communication, including but not limited to Global System for Mobile Communications (GSM), Enhanced Data GSM Environment (EDGE), high-speed downlink packet access (HSDPA), wideband code division multiple access (W-CDMA), code division multiple access (CDMA). time division multiple access (TDMA). Bluetooth, Wireless Fidelity (Wi-Fi) (e.g., IEEE 802.11a. IEEE 802.11b, IEEE 802.11g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

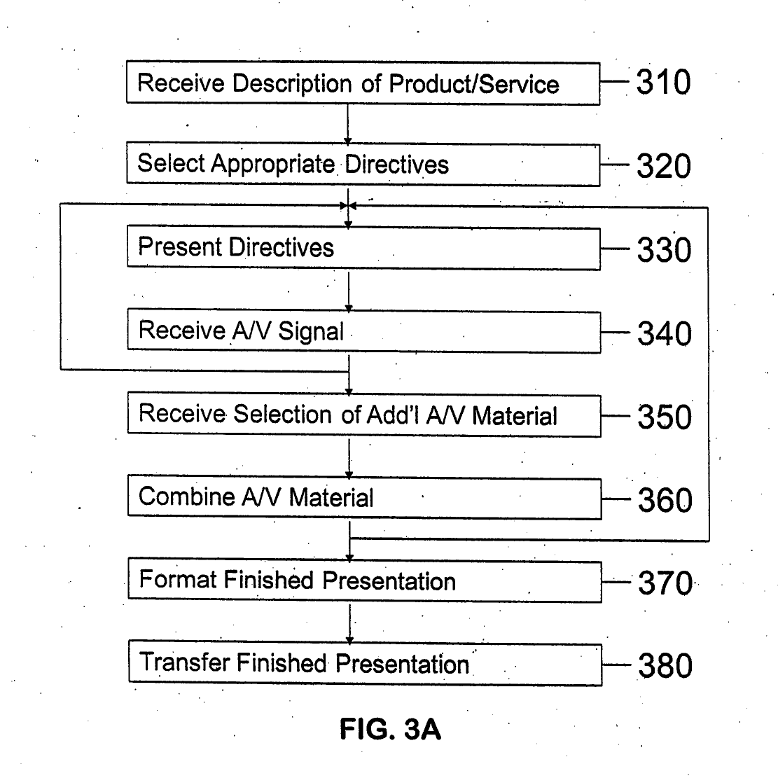

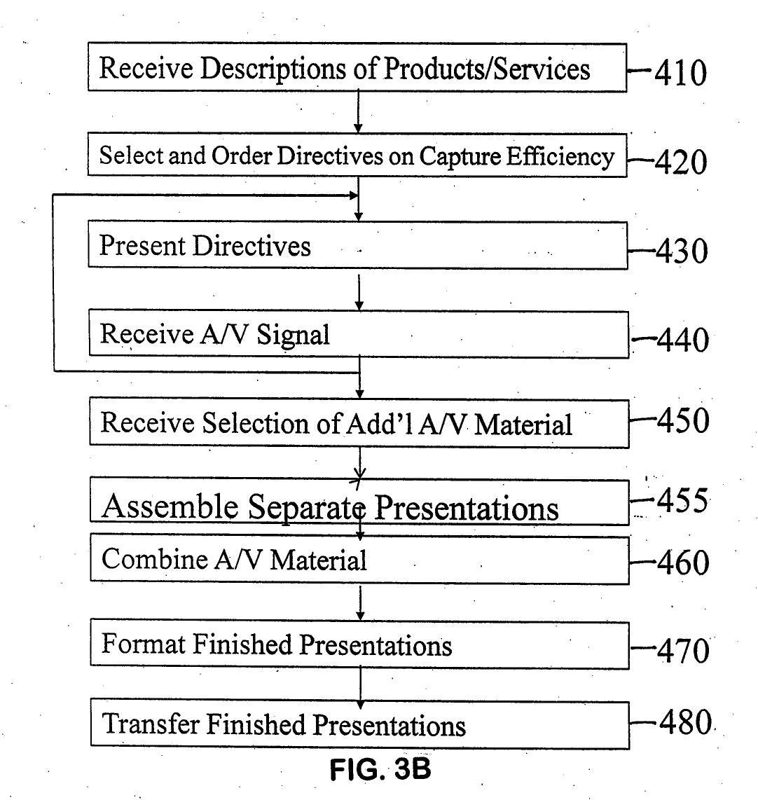

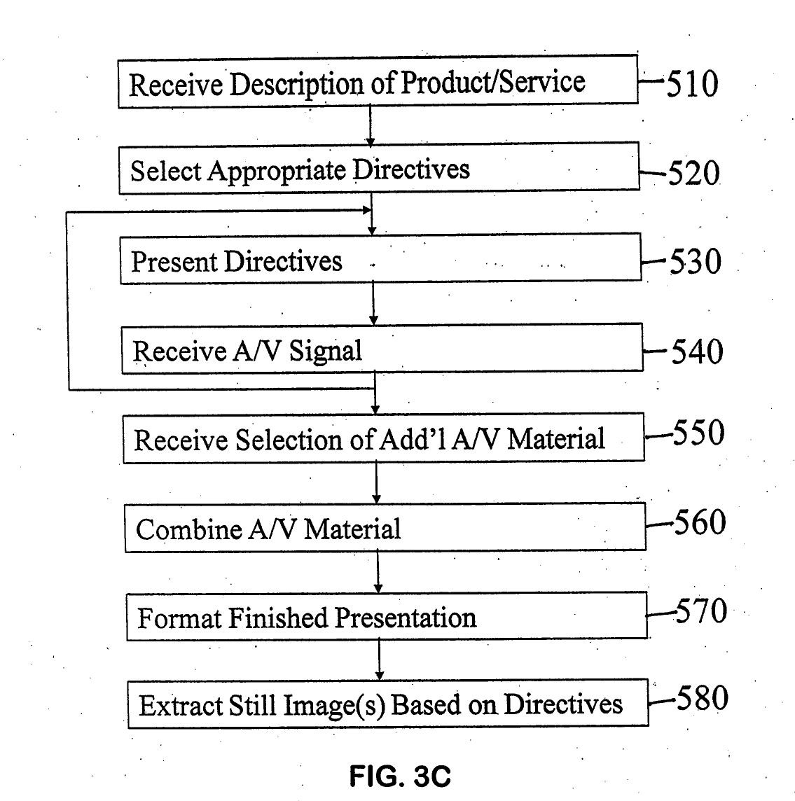

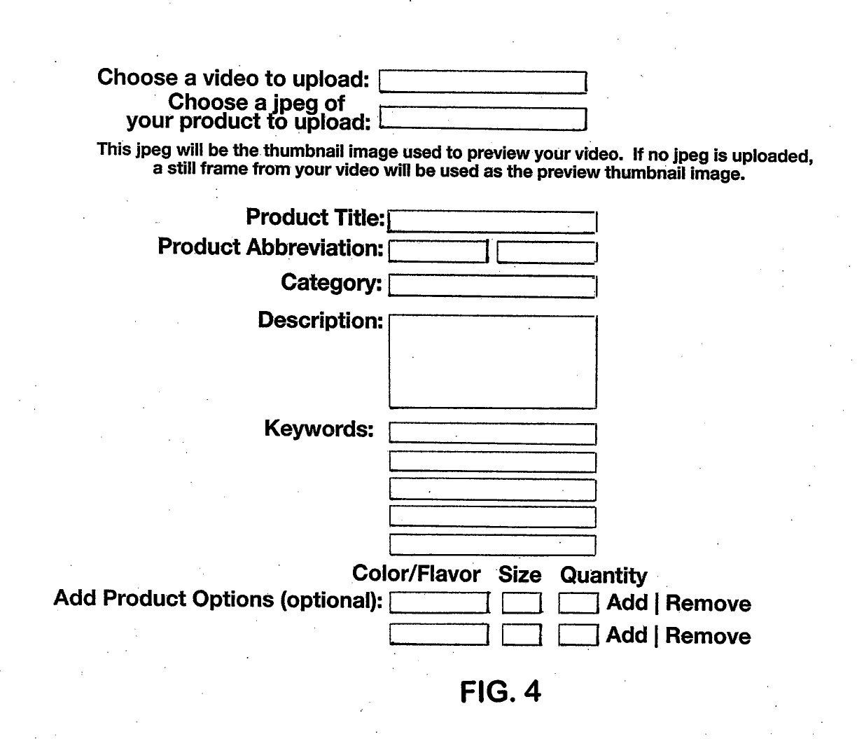

FIG. 3A is a flowchart depicting the operation of an illustrative embodiment of the invention. At step 310, processing unit 110 receives a description of the product or service that is to be the subject of the audiovisual presentation when the user enters that description into a data entry form displayed on display 153. An illustrative embodiment of the data entry form is depicted in FIG. 4. At step 320, the processing unit 110 determines from the description it receives the category of product or service that is to be the subject of the presentation and selects from its memory a set of directives for the creation of an audiovisual presentation relating to that category. Illustrative examples of these directives are set forth below in paragraph 0035. At step 330, processing unit 110 begins to present these directives to the user using suitable audio and/or visual devices available to it, such as, speaker 134 and display 153. In response, the user begins to record the presentation using, for example, microphone 132 and camera 156. At step 340, the audio and video signals from microphone 132 and camera 156 are received by processing unit 110 and stored in memory 170. Advantageously, processing unit 110 also monitors the received audio and video signals and issues additional directives upon detecting certain events. For example, at a predetermined time after commencement of the presentation, the user might be instructed to obtain a close up of the product that is the subject of the presentation. Or speech patterns might be monitored and the user instructed to speak up, or slow down, etc. as appropriate. Or the video might be monitored and the user instructed to smile more often, etc. The steps 330 and 340 of presenting instructions and receiving the audio and video signals of the presentation continue until an initial version of the presentation is made.

At this point the user is offered the opportunity to review the presentation and steps 330 and 340 are repeated as necessary until a presentation is completed that is acceptable to the user. In some embodiments, the user then selects additional pre-produced audiovisual files to be automatically combined with the presentation. This selection is received at step 350 by the processing unit. At step 360, the processing unit combines the pre-produced audiovisual files with the presentation completed at step 340. This presentation is then reviewed by the user. If desired, the process can return to steps 330-360 to make further changes to the presentation until a presentation is completed that is acceptable to the user. In step 370, the presentation is then coded automatically by the processing unit in a format optimized for Internet or broadcast delivery. Illustratively, this coding step also involves compressing the audiovisual record of the presentation At least some of this compression may be achieved by automatically separating the audio and video portions of the presentation and then automatically recombining the audio and video portions into a finished presentation in accordance with a predetermined set of rules. These rules, for example, may specify that certain segments of the audio and video portions be reduced in length or that dissolves be used to transition between certain adjacent segments. In step 380, the processing unit automatically transfers the audiovisual file of the finished presentation to the appropriate disk drive, whether local or remote, for said Internet or broadcast delivery.

Some examples of user directive sets mapped to a product type are:

### Inventions

a. What problem does this product solve? This may include a brief story of where the idea came from.

b. What are the product's unique features and benefits? Show me.

c. How does it work? Demonstrate how it works. Show how easy it is to use.

d. Why is this better than similar products? Consider demonstrating how it works compared to a similar item.

e. Raise and answer obvious questions and objections. For example . . . Will I know how to work it when I get it? Will this hold up to prolonged use? Will this soon be outdated? Is this easy to store? Is it expensive to operate? What if it needs to be repaired?

f. Is the distribution of this item limited? If so, it is a powerful reason to purchase.

g. Why is this a good value? Justify why your product is worth the cost. Is it better quality than similar items? Is it easier to use? Does it save you time or money?

### Unique Jewelry

a. What is it? What do you get? What is the inspiration behind creating it?

b. Show me the details. What is it made of? Who made it? Where do the materials come from?

c. What are the features and benefits? How is it made? What is the heritage? Is it handcrafted? How does it feel? How unique is each piece?

d. Show me how to wear it. What outfits would you accessorize with this?

e. Is the distribution of this item limited? If so, it is a powerful reason to purchase.

f. Why is this a value?

### Boutique Fashion

a. What is it? What is the material? The weave? The pattern?

b. What do you get?

c. Show me how to wear it.

d. What makes this better than something similar? Give me a tour of the piece

e. How does it feel?

f. Show me the unique features and details that differentiate it.

g. Why is this great to buy right now? It is on trend? Seasonal?

h. What would you wear this with? Demonstrate your fashion credibility

i. What are the measurements? Does this fit true to size or would you size up or down?

j. Is the distribution of this item limited? If so, it is a powerful reason to purchase.

k. Why is this a good value?

### Natural Beauty

a. Why is this brand trustworthy? Explain.

b. What does this product promise to do for me?

c. Show me what it can do. Before and after live demos or photos are best.

d. What proof can you offer that it will perform as promised? Clinical studies? Claims related to active ingredients? Testimonials?

e. How will it make you feel?

f. How will it make you look?

g. How will it change the way other people perceive you when you are using the product?

h. Is the distribution of this item limited? If so, it is a powerful reason to purchase.

i. Why is this a good value?

### Home Design

a. What is it?

b. How does it work? Show me.

c. What problem does it solve? Before and after demonstrations are good.

d. Show the craftsmanship/quality of construction. Is each piece individually crafted?

e. What makes this better than something similar? Show me what is unique about it.

f. Why is this great to buy right now? It is on trend? Seasonal?

g. Where in the home does it work? Show me how this works in a home setting. What styles of decorating will this coordinate with?

h. What statement does this make in a room?

i. Is the distribution of this item limited? If so, it is a powerful reason to purchase.

j. Why is this a good value?

### Gourmet Food

a. What is it? What do you get? Is it intended as a gift or self purchase? Position it accordingly.

b. Explain the brand. How is it made? Is it homemade, regional, organic, etc.

c. What is unique about this food? Cut into it or break it open. It is of utmost importance to show close-ups of the texture that differentiate it from similar foods! Show that the consistency is firm, creamy, chunky, tender, juicy etc.

d. What does it taste like? Eat it. Describe the aroma, the flavor the texture. Enjoy it!!!

e. How do I serve this? Show me ideas?

f. Will it be fresh when I receive it? How is it packaged/shipped?

g. Is the distribution of this item limited? If so, it is a powerful reason to purchase.

h. Why is this a good value?

### Original Music

a. Start with music!

b. What is unique about this artist? What is the artist's story? How is this different from similar music?

c. Play as much music as you can—live performance is best. For most music it is best to play short pieces from many songs rather than longer segments. Ideally. set up each piece to explain to the listener what is unique before they listen.

d. If you are not the artist, it is very important to react with enthusiasm to each music segment as it ends.

e. What is the artist's inspiration? What does he or she say about the music? What have others said about the music? Is the music timely or current?

f. How does the music make you feel?

g. Is the distribution of this item limited? If so, it is a powerful reason to purchase.

h. Why is this a good value?

### Baby Gifts

a. What is unique about this gift?

b. Demonstrate what it does.

c. Is this safe? Explain why.

d. What will this do for the baby? Make them happy, content or comfortable?

e. What age range is this appropriate for?

f. Why should you feel good about giving this as a gift?

g. Is the distribution of this item limited? If so, it is a powerful reason to purchase.

h. Why is this a good value?

FIG. 3A shows the progression of the directed transformation of the video into digital audiovisual files, automated algorithmic enhancement through compression or otherwise, and automated categorization of the video. As a result, the time consuming and expertise driven activities of editing, outputting, encoding, and uploading are taken care of automatically by the invention without further user input, saving the majority of the time it takes to utilize manual video editing and video production techniques.

FIG. 3A illustrates that the directives can be scaled up or scaled down in terms of how many directives per video, and after each directive is completed by the user, the user

reviews his or her work and approves or retries the directive to allow for user feedback during capture (steps 330 and 340). In other embodiments, the final digitally transformed audiovisual can be created without the intermediate steps 330 or 340, or steps 330-360 can be repeated if a user wants to further enhance a finished digitally transformed audiovisual either during the original device session or after the original device session.

FIG. 3B is a flowchart depicting the operation of a second embodiment of the invention. This embodiment is similar to that of FIG. 3A but provides for the preparation of at least one of the same or similar portions of a plurality of video presentations in a series, one immediately after the other. For example, if a desired group of jewelry presentations for rings involve a 360 degree view of each ring coupled with a view of the ring on a model's finger, then it is likely to be more efficient to take all 360 degree views of the rings in a series in one video session and to take all the views of the rings on the model's finger in a series in a second video session rather than have two separate video sessions for each ring. In this way, for example, camera and lighting setups do not need to be adjusted as frequently; the use of the model can be limited to a single session; and considerable time can be saved.

The steps for implementing this second embodiment are substantially the same as those of the first embodiment depicted in FIG. 3A and they bear the same numbers in FIG. 3B incremented by 100. However, one or more of the steps of FIG. 3B relates to a plurality of products, profiles, services or presentations. For example, information may be received in step 410 that describes a plurality of products or services for each of which products or services a separate presentation video is to be made. In these circumstances, the directives that are generated in step 420 and presented in step 430 for the preparation of the presentation videos are selected and ordered so as to direct the generation of at least one same or similar portion of each presentation video in a series, one portion immediately after the other. The video material that is captured is then edited automatically to move the different portions of the video material to the proper presentation video and assemble a separate presentation video for each product, profile, service or presentation. Illustratively, this editing step is performed as step 455 before additional AN material is combined with the separate presentation videos at step 460. If desired, it may be performed at other steps in the process as well.

FIG. 3C is a flowchart illustrating the operation of a third illustrative embodiment of the invention. Most of the steps performed in this embodiment are the same or similar to those of the first or second embodiments described above and will not be described again. For purposes of illustration, FIG. 3C follows the flowchart of FIG. 3A and the steps of FIG. 3C have been numbered with the same numbers incremented by 200. As shown in FIG. 3C, the third embodiment comprises the additional step 580 of extracting still image(s) from the presentation video. This extraction can be performed automatically following instructions that tell the processor where to find the video images that are to be extracted to form the still images. Alternatively, this extraction step may be performed manually by an operator who views the presentation video and designates the video frames that appear to be most suitable for use as still images. Following extraction of the still images, the still images are provided to the customer along with the presentation video.

FIG. 4 is an illustrative example of the data input form that the user uses in step 310 to describe his product, profile, service, or presentation background data to the processing unit. This data is used by the processing unit to generate the directives based on preprogrammed scripts stored in memory 170.

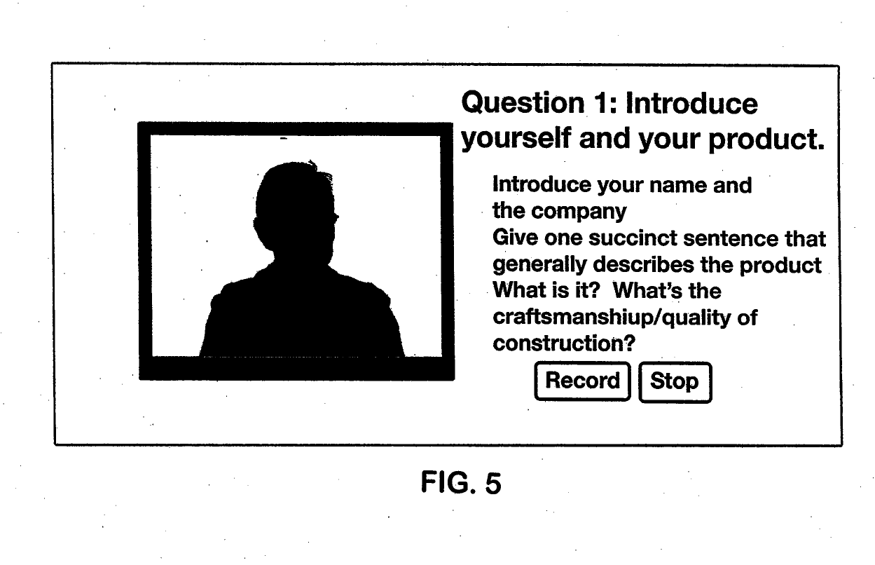

FIG. 5 is an example image of the device's graphical user interface (GUI) where the user is directed by display 153 in step 330 to capture video according to the displayed directive.

The user can select the camera he or she will use and the audio input he or she will use. The audio and video inputs are monitored by processing unit 110 and the video input is displayed on display 153.

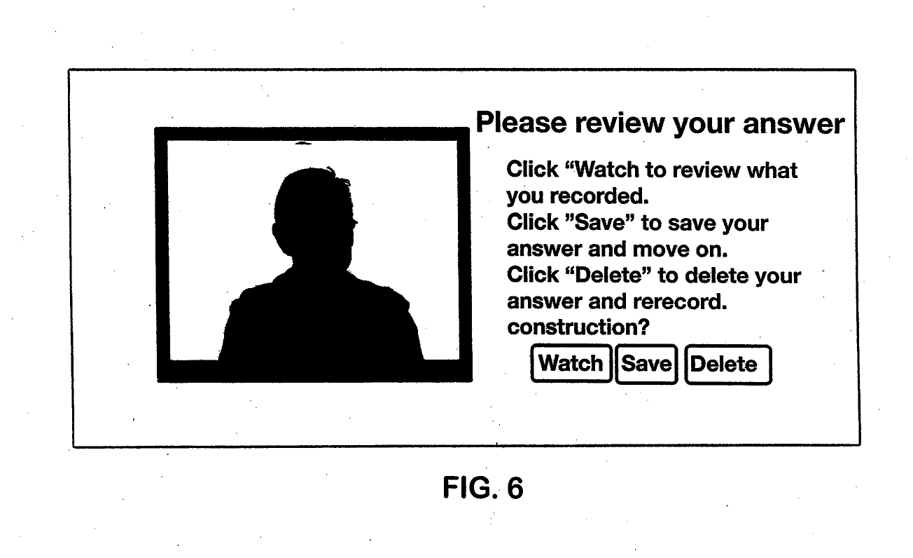

FIG. 6 is an example image of the device's GUI where the user is prompted to review his or her video recording. Based on the user's own feedback and criteria presented to the user in the interface, the user can choose to redo their recording or move on to the next directive.

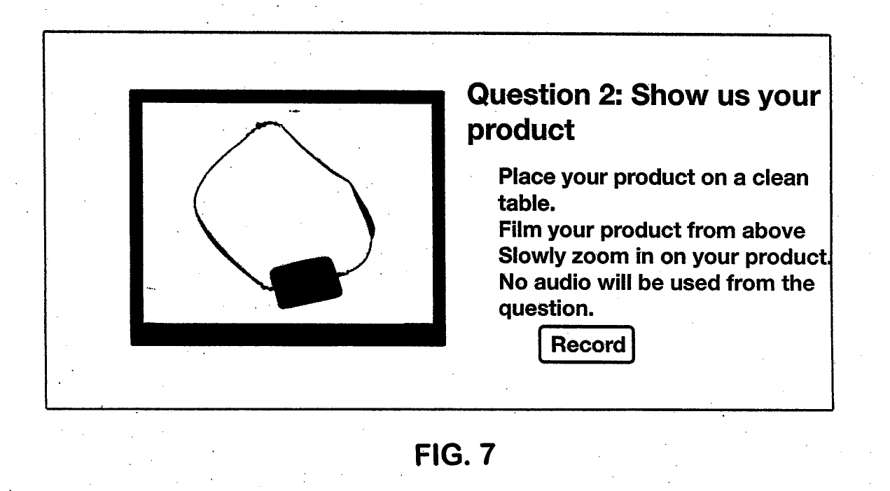

FIG. 7 is an example image of the device's GUI where another directive is put forth to the user whereby the user is instructed on how to showcase a product in front of his camera.

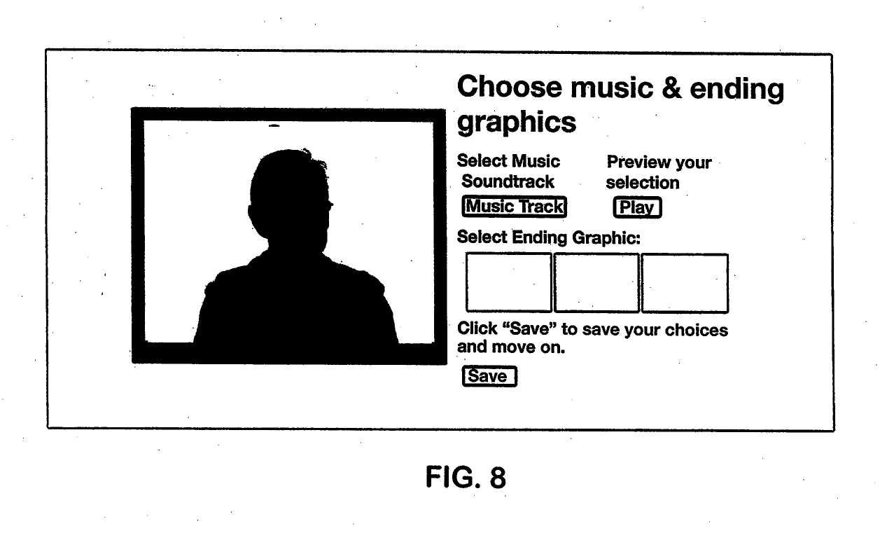

FIG. 8 is an example image of the device's GUI where the user is prompted to choose a soundtrack and motion graphic to enhance the presentation. Mixing in music underneath the spoken portion of a recording and creating/adding motion graphics such the examples in this FIG. 8 take significant technical skill. In the present invention these complicated tasks are executed by the device as it automatically further transforms the audiovisuals and enhances them by the methods herein, and the interface involves quick and simple visual menus, without the need for the user to make technical calculations or manually handle mixing.

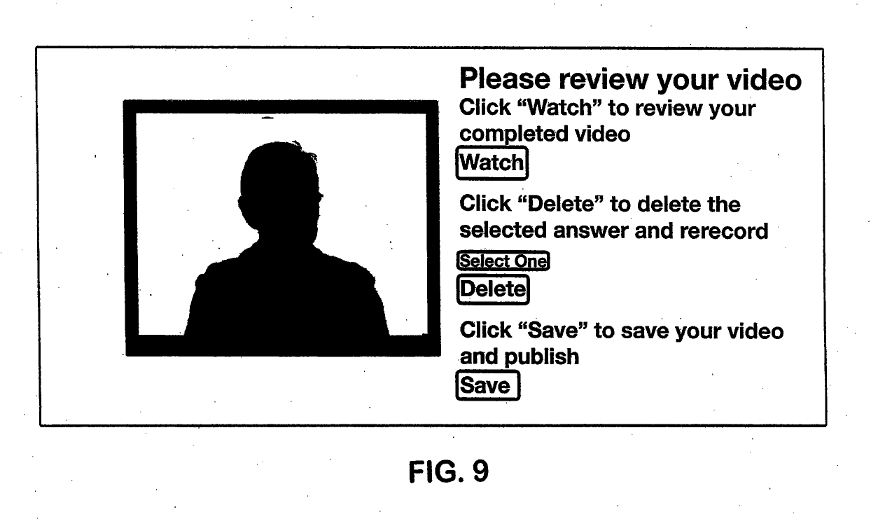

FIG. 9 is an example image of the device's GUI where the user is prompted to review his or her entire video and is given the opportunity to redo any of the previous directed recordings. The automatic editing algorithm has already enhanced the video recordings, soundtracks, and motion graphics, further transforming the digital files by combining them optimally, automatically and quickly, without the user needing to utilize traditional manual video editing software and the time it would take to edit manually and without the user needing to possess the expertise required to do so. At this point, the user can review the completed result before making a decision to have the device edit it further or publish the video to the correct server directory automatically.

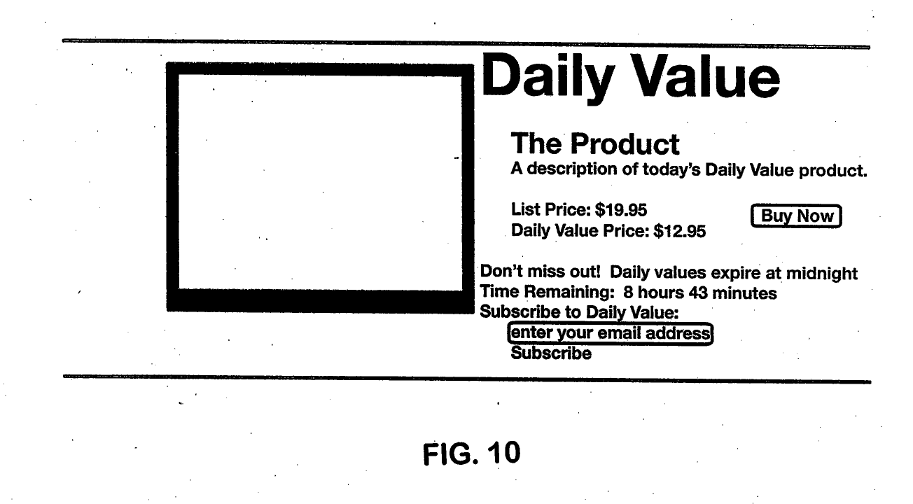

FIG. 10 is an example image of the published video created through the process outlined in FIGS. 3-9 on an example ecommerce product detail page. The device categorizes the video according to the data entered and adds the video to a linked ecommerce listing page after placing the file in the proper network server-accessible directory, so the normal outputting, transcoding, and cataloging of content in the traditional production and uploading process is not necessary. Valuable time is saved. The product featured in the sale video is ready to be purchased by customers.

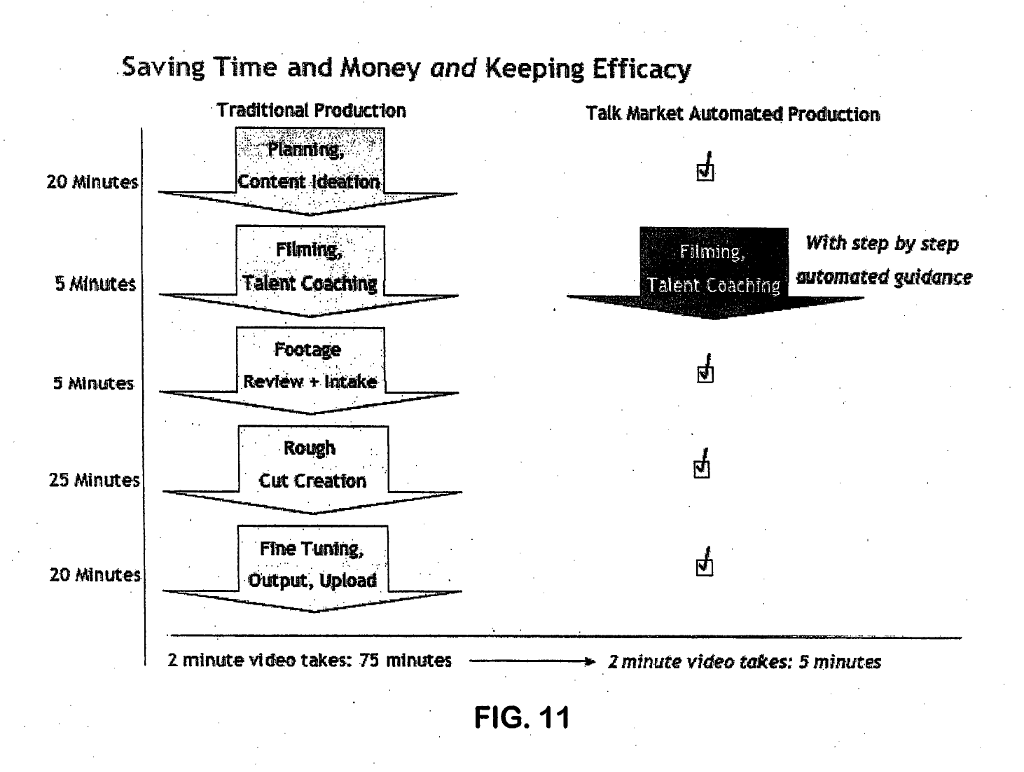

FIG. 11 is an illustration of the traditional presentation video production process and a comparison showing the steps saved by the invention's automatic transformative components. Thus, a 75 minute largely manual process that takes expertise and money can be performed in 5 minutes with the present invention, and no expertise is required, thereby saving more resources. Hence, massive content creation is for the first time possible for ecommerce sites with thousands of SKUs, or for unskilled users who need to create higher quality presentation videos quickly and easily.

As will be apparent to those skilled in the art, numerous variations may be made in the practice of the invention within the spirit and scope of what is set forth in the claims.

What is claimed is:

1. A computing device, comprising:
a display;
one or more processors;
memory;
a camera, and
one or more programs, wherein the one or more programs are stored in the memory and configured to be executed by the one or more processors, the one or more programs including:
instructions for mapping video capture directives to video subject data entered by the user;
instructions to transform audio and visual signals into digital audiovisual files according to the directives, instructions to allow the user to configure a destination file directory for the finished presentation videos; and instructions to further transform the digital audiovisual files without further user input by automatically separating audio and video portions of the audiovisual files, by automatically recombining audio and video portions of footage according to predetermined rules to contract and enhance the audiovisual files, and by transferring resultant enhanced video and related metadata to a database server for later network based delivery in conjunction with an ecommerce product detail web page or user profile.

2. The computing device of claim 1, wherein the computing device is located in the user's proximity, or wherein the user utilizes a close proximity Internet connected computer to operate the computing device of claim 1 via an Internet connection, or wherein the user utilizes a close proximity Internet connected computer and camera to operate the computing device of claim 1 via an Internet connection.

3. A computing device, comprising: a display; one or more processors; memory; a camera, and one or more programs, wherein the one or more programs are stored in the memory and configured to be executed by the one or more processors, the one or more programs including: instructions for mapping video capture directives to video subject data.

4. The computing device of claim 3, wherein the one or more programs include instructions to form digital audiovisual files using signals from the camera and an audio input.

5. The computing device of claim 4, wherein the computing device contains instructions to further transform the digital audiovisual files by automatically separating audio and video portions of the audiovisual files, to automatically recombine audio and video portions of footage according to predetermined rules to compress and enhance the audiovisual files, and to transfer resultant enhanced video and related metadata to a database server for later network based delivery in conjunction with an ecommerce product detail web page or user profile.

6. The computing device of claim 5, wherein the computing device contains instructions to further digitally transform the audiovisual files to enhance the digital files with the methods herein after the process of claim 5 is completed.

7. The computing device of claim 3, wherein the computing device contains instructions to digitally transform the audiovisual files to enhance the digital files with the methods herein without creating intermediate digital files or by enhancing the files in “real time.”

8. The computing device of claim 3, wherein the computing device is located in the user's proximity, or wherein the user utilizes a close proximity Internet connected computer to operate the computing device of claim 1 via an Internet connection. or wherein the user utilizes a close proximity Internet connected computer and camera to operate the computing device of claim 1 via an Internet connection.

9. A method of making a presentation video comprising:
receiving at a computer information concerning proposed subject matter for the presentation video;
providing from the computer instructions for making the presentation video in response to the information received concerning the subject matter of the video;
receiving at the computer audiovisual signals representing a first draft of the presentation video;
automatically enhancing the presentation video with additional audio and/or visual effects;

10. The method of claim 9 further comprising the steps of:
automatically separating audio and video portions of the audiovisual signals, and
automatically recombining the separated audio and video portions according to predetermined rules to contract and enhance the presentation video.

11. The method of claim 9 further comprising the step of transferring the presentation video to a database server for network based delivery .

12. A method of preparing a sales video comprising:
receiving at a computer identification of a product or service that is to be the subject of the sales video;
generating at the computer step-by-step instructions to a user specific to the subject of the video on what to say in the video, when to say it and how to film the subject of the sales video;
providing the step-by-step instructions from the computer to the user; and
editing the sales video at the computer.

13. The method of claim 12 further comprising the steps of;
automatically separating audio and video portions of the sales video; and
automatically recombining the separated audio and video portions according to predetermined rules to contract and enhance the sales video.

14. The method of claim 12 further comprising the step of transferring the resultant sales video to a database server for network based delivery.

15. The method of claim 12 further comprising the step of automatically enhancing the sales video with additional audio and/or visual effects.

16. The method of claim 12 wherein the computer receives identification of a plurality of similar products or services that are to be the subject of sales videos and the step of generating step-by-step instructions for preparation of the sales videos comprises the step of generating step-by-step instructions for making at least one portion of the sales videos for the plurality of similar products or services in series, one portion after the other.

17. The method of claim 12 further comprising the step of extracting from the sales video at least one still image.
